(19) United States
(12) Patent Application Publication
(10) Pub. No.: US 2025/0291805 A1
(43) Pub. Date: Sep. 18, 2025

(54) ENTITY INFORMATION GENERATION

(71) Applicant: Sentry Insurance Company, Stevens Point, WI (US)

(72) Inventors: Jacob Zastrow, Stevens Point, WI (US); Michele Praefke, Stevens Point, WI (US); Todd Gasall, Stevens Point, WI (US); Aaron Deering, Stevens Point, WI (US); Travis Norwood, Stevens Point, WI (US)

(73) Assignee: Sentry Insurance Company, Stevens Point, WI (US)

(21) Appl. No.: 19/064,246

(22) Filed: Feb. 26, 2025

Related U.S. Application Data
(60) Provisional application No. 63/566,605, filed on Mar. 18, 2024.

(51) Int. Cl. G06F 16/2457; G06F 16/248

(52) U.S. Cl. CPC G06F 16/24578; G06F 16/248

(57) ABSTRACT

Entity information generation is provided. A method includes receiving a signal corresponding to a first interaction with an entity. The method includes determining an indication of an entity identity based on the signal. The method includes receiving a query associated with the entity, based on the entity identity. The method includes generating, responsive to the query, interaction basis information, the interaction basis information based on the signal. The method includes presenting the interaction basis information via a user interface.

### CROSS-REFERENCE TO RELATED APPLICATION

This application claims priority to U.S. Provisional Patent Application No. 63/566,605 entitled “ENTITY INFORMATION GENERATION,” filed Mar. 18, 2024, which is incorporated herein by reference in its entirety.

### FIELD

This disclosure generally relates to systems and methods for generation of entity information, such as information associated with previous interactions with a client, based on signals exchanged between various data stores and interfaces of a network.

### BACKGROUND

Modern organizations rely on a variety of data stores across an enterprise. Each of these data stores may include distinct identification for one or more product types, and may store different information or differing formats for information (e.g., different length fields, account number formats, or so forth). Various relational databases, interfaces, or other data structures can be configured to operate with different systems. For example, a technical support team can use one or more data stores to help users reset login credentials, such data stores can vary from a data store used by a sales team to configure a product offering. Further, data stores can include non-indexed or unstructured information such as user call notes or logs. Although cross-data store information sharing may provide useful insight to various users of a system, systems and information may not be configured to readily intercommunicate. Harmonizing the various data sources across an organization can constitute a substantial undertaking, and may lead to data coherency or other issues, according to at least some implementations.

### SUMMARY

This technical solution can interface with various data stores of an enterprise management system to generate relevant information, without harmonizing the various data sources. For example, according to the systems and methods of the present disclosure, an interaction with an entity, such as a web site visit, a record of a phone call, or an email is generated as a signal including one or more data fields. A monitoring system configured to interface with various data stores can receive (e.g., intercept) the signal corresponding to the interaction. For example, the signal can be generated incident to communication between a web site and an insurance policy database, responsive to a change entered by the user. The monitoring system can detect an indication of an identity, such as a policy number, name, user login information, or so forth, and store the signal. Thereafter, the monitoring system can receive a query associated with the entity. For example, the user which previously accessed the website may call a support number, which can cause the monitoring system to be queried. Responsive to the query, the monitoring system can retrieve and present the stored signal. For example, the monitoring system can present the information to a client support agent, who can assist the user based on the information.

At least one aspect is directed to a method. The method can be performed by one or more processors, coupled to memory. For example, the one or more processors can be processors of a data processing system such as an entity information generator. The method includes receiving a signal corresponding to a first interaction with an entity. The method includes determining an indication of an entity identity based on the signal. The method includes receiving a query associated with the entity, based on the entity identity. The method includes generating, by the one or more processors and responsive to the query, interaction basis information, the interaction basis information based on the signal. The method includes presenting the interaction basis information via a user interface.

At least one aspect is directed to a non-transitory computer-readable medium. The medium includes instructions stored thereon, the instructions being executable by a processor to cause the processor to perform operations. The operations include receiving a signal corresponding to a first interaction with an entity. The operations include determining an entity identity based on the signal. The operations include receiving a query associated with the identified entity. The operations include generating, responsive to the query, interaction basis information based on the signal. The operations include prioritizing the interaction basis information for display. The operations include presenting prioritized interaction basis information via a user interface.

At least one aspect is directed to a server. The server is configured to receive, from a plurality connectors corresponding to a plurality of data sources, a first plurality of signals corresponding to one or more first entity interactions. The server is configured to determine, based on one or more of the first plurality of signals, an indication of an entity identity. The server is configured to receive a query associated with the entity, a data field of the query corresponding to the entity identity. The server is configured to generate, responsive to the query, interaction basis information for presentation to a client support agent, the interaction basis information based on the signal. The server is configured to present the interaction basis information.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a system for generating entity information, according to some embodiments.

FIG. 2 depicts a data flow diagram indicating a data flow associated with the entity information generator of FIG. 1, according to some embodiments.

FIG. 3 depicts a user interface to present interaction basis information, according to some embodiments.

FIG. 4 is an entity relationship diagram depicting a variety of entities associated with an organization and communication channels, according to some embodiments.

FIG. 5 depicts an example data flow diagram for a method of entity information generation, according to some embodiments.

FIG. 6 is a block diagram illustrating an architecture for a computer system that can be employed to implement elements of the systems and methods described and illustrated herein.

### DETAILED DESCRIPTION

Following below are more detailed descriptions of various concepts related to, and implementations of, methods, apparatuses, and systems of data access control and presentation. The various concepts introduced above and discussed in greater detail below may be implemented in any of numerous ways.

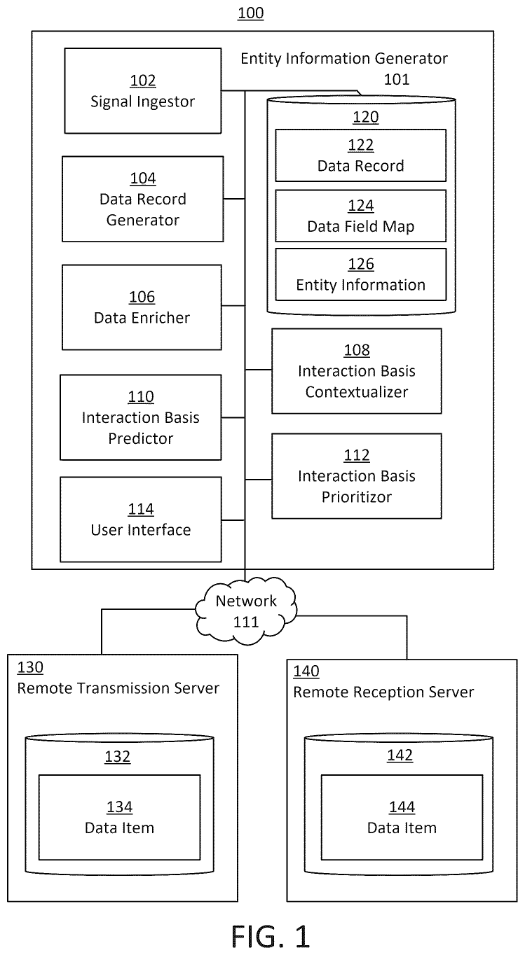

FIG. 1 depicts a system 100 including at least one transmission server 130 and at least one reception server 140, according to some embodiments. The transmission server 130 is configured to convey a signal to another portion of the system 100 (or a device interfacing therewith) such as the reception server 140. The reception server 140 is configured to receive information from another device, such as the transmission server 130, or another device interfacing with the system 100. In an illustrative example, the transmission server 130 can include a rules database configured to transmit a signal associated with a requested insurance coverage change, quote, or so forth, and the reception server 140 can be a web server configured to receive the signal, for presentation of an effective coverage date, coverage information, price, or other information. Some servers can operate as a reception server 140 in a first instance, and as a transmission server 130 in a second instance. Continuing the previous example, the web server can transmit a signal indicative of a confirmation of an account change to the rules database server, or to another device, wherein the web server is a transmission server 130 and the rules database server or other device is the reception server 140. Some signals can include data conveyed between more than two devices, and in many instances, one or more operations can generate multiple signals such as multiple signals between two or more devices. Each of the transmission server 130 and the reception server 140 can include a data store (e.g., a respective data repository 132, 142) or interface to receive information from or convey information to, such as a web form.

The entity information generator 101 is configured to interface with various data stores, such as the depicted remote transmission server 130 and remote reception server 140, to generate entity information 126 based on a receipt of various signals. The entity information generator 101 can include or interface with at least one signal ingestor 102. The entity information generator 101 can include or interface with at least one data record generator 104. The entity information generator 101 can include or interface with at least one data enricher 106. The entity information generator 101 can include or interface with at least one interaction basis contextualizer 108. The entity information generator 101 can include or interface with at least one interaction basis predictor 110. The entity information generator 101 can include or interface with at least one user interface 114. The signal ingestor 102, data record generator 104, data enricher 106, interaction basis contextualizer 108, interaction basis predictor 110, or user interface 114 can each include at least one processing unit or other logic device such as programmable logic array engine, or module configured to communicate with the data repository 120 or database. Any of the elements of the entity information generator 101 can further interact with (e.g., monitor) a transmission server 130 or reception server 140, such as the signal ingestor 102 to receive (e.g., intercept) signals therebetween.

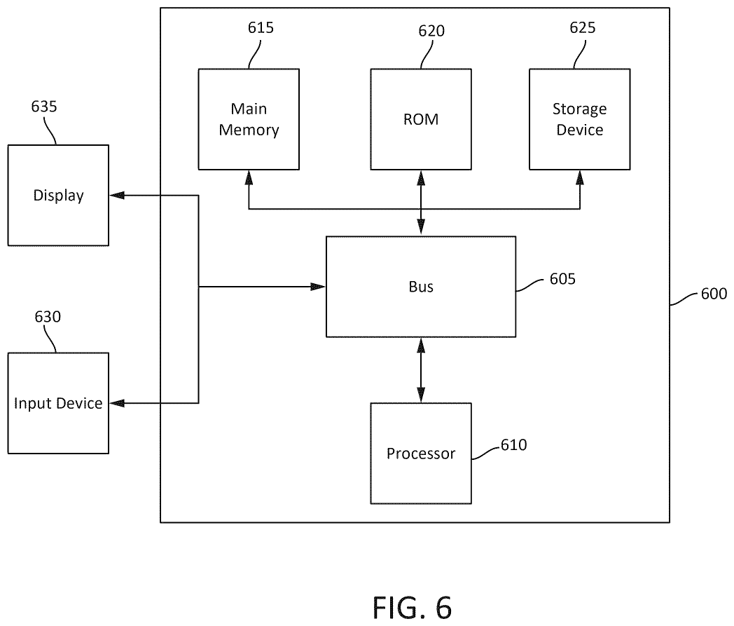

The signal ingestor 102, data record generator 104, data enricher 106, interaction basis contextualizer 108, interaction basis predictor 110, or user interface 114 can be separate components, a single component, or part of the entity information generator 101, and can include or interface with, or be components of, the system 100 including various data stores and interfaces. The entity information generator 101 can include hardware elements, such as one or more processors, logic devices, or circuits. For example, the entity information generator 101 can include one or more components or structures of functionality of computing devices depicted in FIG. 6.

The various components of the system 100 can be in network communication across any number of data links to communicatively couple the various components. Network connections can include, for example, connections to Peripheral Component Interconnect Express (PCIe), Ethernet, wireless fidelity (Wi-Fi) or any number of other wired or wireless networks 111. The network 111 can include computer networks such as the Internet, local, wide, metro, or other area networks, intranets, cellular networks, satellite networks, and other communication networks such as Bluetooth, or data mobile telephone networks. The network 111 can be public or private. The various elements of the system 100 can communicate over the network 111.

The data repository 120 can include one or more local or distributed databases, and can include a database management system. The data repository 120 can include computer data storage or memory and can store one or more data structures, such as a data record 122, a data field map 124, or entity information 126.

A data record 122 can include one or more data fields including information derived from or associated with a signal. For example, a data record 122 can include an indication of a user action such as a login or attempted login to an account, a call placed to a call center, a change to an account made via a web form, an automatic or manual renewal or non-renewal of a policy, or so forth. The data record 122 can include an indication of recency (e.g., a timestamp), along with any other information available incident to the generation of a data item, the data record 122, or a subsequent enrichment thereof.

Some data records 122 can include client surveys, client support agent notes, or other indications of a resolution of a previous interaction, which may be, in some instances, helpful or predictive with respect to an ongoing or impending entity interaction (e.g., client call). The data record 122 can include a method of contact for electronic communication (e.g., web-interface, phone call, email, etc.). The data record 122 can include an address such as an email address, phone number, or so forth. The data record 122 can include an indication of identity such as a policy number, name, email, phone number, etc. According to various embodiments, the data record 122 can include any entity information 126. The data record 122 can include a first portion of information available upon its creation, and further information added to the data record 122 incident to one or more data record operations. For example, an initial data record 122 can include a phone number, time stamp, an indication of a basis for the interaction (e.g., to make a payment, change coverage, etc.), and a client support agent associated with the interaction. A subsequent data enrichment can provide an identity of the client support agent, department of communication, or any other information.

A data field map 124 can include a mapping of one or more data fields between one or more data stores or interfaces. For example, a data field map 124 can map an account number between various formats or storage locations. For example, a first data field can include an account number according to a first format which can correspond to other formats stored in other locations (e.g., 12345 or 12-345). Further, various data fields may map to a same value, such as an “Account_Number,” “AcctNbr” or “ACT_ID” field. The data field map 124 can further store information between different locations. For example, a first location can store an index value for a client support agent, and the data field map 124 can store a linkage to a second location corresponding to a name, department, qualification skills, or so forth. That is, the data field map 124 can include associations between various data repositories, such as the depicted data repository 120, second data repository 132, and third data repository 142.

Entity information 126 can include any information associated with an entity. The entity information 126 can include, for example, an account number, contact information, or an indication of one or more sub-entities (e.g., employees of a company, insured parties of an insurance policy, etc.). The entity can include, for example, a company, family, individual, or other assemblage of one or more sub-entities. Entities and sub entities may be referred to in a cascading manner, such that where a company is referred to as an entity, various departments thereof can be referred to as sub-entities Further, employees of the department may be referred to as sub-entities of the entity of the department. Entity information 126 can include information concerning any number of accounts, such as a renewal status, payment status, binding, payment history, or so forth. The entity information 126 can include information associated with any number of data stores. For example, an entity can be associated with one or more account types (e.g., insurance policies), such as automotive insurance policies, property insurance policies, general liability insurance, or workers compensation insurance, employment practices liability insurance.

A second data repository 132 includes first data items 134. The nature of data items can vary according to a data repository function. For example, a system configured for mailing notices can include a name, account number, indication of electronic mail opt-in, and so forth. A system configured to store policy information can include a claims history, coverage level, risk factors, and so forth. Although depicted as a data repository 132, various system 100 components can include interfaces which do not locally store at least a portion of data items 134. For example, a web form interface can receive and convey signals related to data items 134 with one or more further system components. The signal ingestor 102 can receive such signals.

A third data repository 142 can include second data items 144, which can include further information included in signals. Any number of other data stores or interfaces can store or provide information which may be ingested, by a signal ingestor 102. For example, one or more signals may be transmitted to or otherwise received (e.g., intercepted) by the signal ingestor 102. Indeed, as indicated above, the depiction of remote transmission server 130 and remote reception server 140 is merely illustrative, and is intended to provide context for the operation of the entity information generator 101. The systems and methods of the present disclosure can be employed in combination with systems 100 including, for example, hundreds or thousands of data stores or other interfaces.

The entity information generator 101 can include at least one signal ingestor 102 to retrieve signals exchanged between various source (e.g., data stores or interfaces of a system 100). The signal ingestor 102 can receive signals according to various formats. For example, various systems can store data according to a JavaScript object notation (JSON), eXtensible Markup Language (XML), comma-separated value (CSV), YAML, text strings, integer data, or so forth. The signal ingestor 102 can ingest a signal addressed thereto. For example, the signal can include any of the information received from various remote servers, wherein the remote servers are configured to provide the signals addressed to the signal ingestor 102 itself. Moreover, some signals can be generated for various destinations, other than the signal ingestor 102. For example, a data source, such as the transmission server 130, can include the signal ingestor 102 as a recipient for various data in addition to another recipient, or a routing instruction of a network router can include an instruction to convey all or a range of messages to the signal ingestor 102. The router can include a signal router implemented in hardware or software, such as for routing according to a routing key or binding of a message broker system (e.g., RabbitMQ).

The signal ingestor 102 can include a connector to retrieve data in flight or at rest, according to various queuing locations. For example, the connector can couple with a message broker or other communications management system to intercept signals between sources and destinations therefor. The signal ingestor 102 can include connectors corresponding to various data sources, such as one or more database or queuing systems (e.g., Rabbit MQ, Confluent KAFKA, SQL, etc.). Each connector can include a monitoring port which conforms to a data structure of the data sources, such that changes of operation to the data source may be obviated. That is, the signal ingestor 102 can intercept signals conveyed between various system 100 components, such that a function of other system components is not modified to operate in conjunction with the entity information generator 101.

The signal ingestor 102 can receive queries associated with an entity. For example, a query can be generated periodically, according to a batch process, to generate or enhance data records 122, or can be based on an ongoing entity interaction. For example, an entity (e.g., a representative thereof) can call into a support center, to contact a human or automated client support agent. Information associated with previous entity interactions may be relevant to the current entity interaction. For example, a display items corresponding to a client calling in shortly after ending a previous call, calling a technical support hotline shortly after failing to update an account online, or who has established a repeated pattern of interaction, such as a series of calls, may be useful to a client support agent. The client support agent or another system 100 component can generate and convey the query to the entity information generator 101, to cause the entity information generator 101 to provide information which may be relevant to the present interaction, sometimes referred to as interaction basis information.

The interaction basis information can include information from data fields of data records 122 of previous interactions with the entity, sometimes referred to as historical records. In some embodiments, the interaction basis information can include interaction basis information received with the query. For example, continuing the example of the call center, the interaction basis information can include an incoming phone number, or an entry received from the user, such as a keypress or a spoken information indicative of a basis for the present interaction (e.g., a selection of a department or a reason for the call). In some embodiments, the interaction basis information may be generated incident to, and coextensive with, a user interaction. For example, responsive to a receipt of a call, the system 100 can generate interaction basis information corresponding to the call during the pendency of the call. Such interaction basis information may be presented to a support agent to aid the support agent in the interaction.

The signal ingestor 102 can convey, to a data record generator 104, a received signal along with any corresponding information. For example, the signal ingestor 102 can identify a sender, addressee, timestamp, format, or other information associated with a signal such that the data record generator 104 can generate a data record 122 including such information.

The entity information generator 101 can include at least one data record generator 104 to create data records 122 associated with the signals received from the signal ingestor 102. The data record generator 104 can generate a record of the signal along with various other data for storage as a data record 122 of the data repository. The data record generator 104 can store the data record 122 including, for example, an entity identity or indication thereof, such as a first communication channel associated with an entity interaction, any data fields associated with a signal, etc. In some embodiments, the entity information generator 101 can thereafter retrieve the data record 122 and compare, for example, a second communications channel to a same data record as the first communication channel, and generate interaction basis information corresponding to both communication channels (e.g., a home and work phone, or a home and cell phone).

The data record generator 104 can cause the data enricher 106 to generate enrichment data prior or subsequent to the generation of the data record 122. For example, the data enricher 106 can perform pattern matching to identify patterns between data fields. For example, the pattern matching can identify a pattern relating to a content of a data field, field heading, or the like. Pattern matching can include, for example, comparing literal strings, n-grams, feature vectors, or other patterns associated with the data fields. The data record generator 104 can generate data records 122 including at least some fields which are agnostic as to a source. For example, differently formatted data fields can be enriched, adjusted, or pruned to conform to a standard data field type. Sets of data fields can be enriched, adjusted, or pruned to conform to a standard data record type. For example, a signal associated with policy binding can include a policy number and indication of binding. The data record generator 104 can cause the data enricher 106 to retrieve, for example, an account number, phone number, or email address associated therewith in the data record 122. Such information can be employed to associate further records (e.g., multiple policies corresponding to an account or phone number).

The data record generator 104 can cause the data enricher 106 to perform various instances or types of data enrichment. For example, the data record generator 104 can cause the data enricher 106 to perform a fast branch of a data enrichment process prior to generating the data record 122. The fast branch can include a predefined operation such as retrieving an account number based on a phone number, or a category based on a client support agent identifier. Subsequent to the generation of the data record 122, the data record generator 104 or the data enricher 106 can append or otherwise modify the data record 122, such as by correcting or supplementing the data record 122. Any data enrichment operations may be performed based on a data field map 124.

The entity information generator 101 can include at least one data enricher 106 to correct, enhance, or otherwise modify information associated with a data record 122. The data enricher 106 can implement multiple branches, such as a first branch to enrich data at a runtime based on a predefined relationship and a second branch to enrich the data as a part of another process, such as an asynchronous or delayed process. For example, the second branch can be processed according to a batch process including various other data records 122. The first branch may be referred to as, for example, “fast” or “synchronous” data enrichment. The first branch can include predefined operations to retrieve further data based on a set of predefined fields or data types. For example, responsive to receiving a “Phone Number” or “Tel_num” field, or in response to receiving a ten digit numeric string, an eleven digit numeric string starting with 1, or a twelve digit numeric string starting with +1 and including ten further numeric digits, the data enricher 106 can perform a lookup and retrieve an account number or name of an entity corresponding to such a telephone number. Such relationships can be manually entered by a user, or can be determined incident to the second (or other) branch.

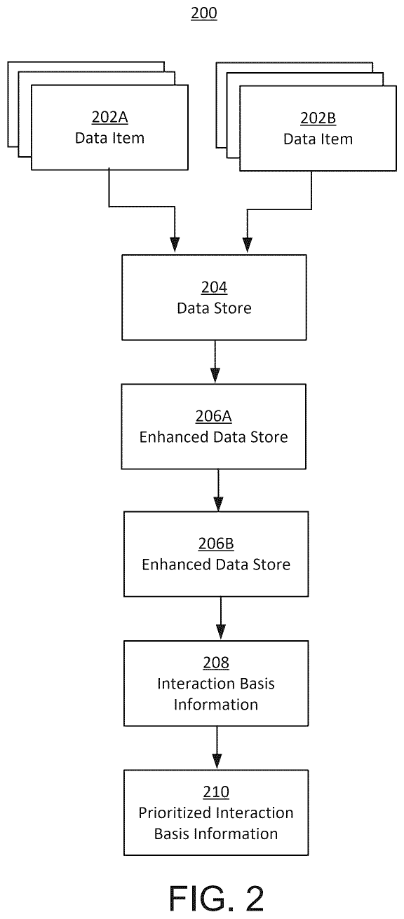

The second branch may be referred to as, for example, “slow” or “asynchronous” data enrichment. The second branch can include determining further associations between various data types. The second branch can be performed to update a display presented to a user. The second branch can include a comparison of various data sources as is further described with regard to the data of FIG. 2. According to various embodiments, the data enricher 106 can include or omit various branches, or substitute, modify, add, etc. various such branches. Some operations of the data enricher 106 may be iterative. For example, enrichment data can be employed to further enrich a data record 122.

The entity information generator 101 can include at least one interaction basis contextualizer 108, configured to generate interaction basis information, referring to a basis for a client interaction. The entity information generator 101 can receive a query, and generate a set of data records 122 responsive to the query. For example, the interaction basis contextualizer 108 can receive a query that includes an indication of a user identity, such as a phone number, account number, name, or other data. The indication of the identity can identify an entity. For example, the indication can indicate an entity, department, geographic location, name of an individual, or the like. The interaction basis contextualizer 108 can retrieve a set of data records 122 associated with that user, or an associated entity. The interaction basis information can include information associated with a related entity, as in a case of a call from a first business unit, wherein a second business unit has made recent or substantial changes to an account. For example, where a user calls from a regional branch location, the interaction basis contextualizer 108 can generate information including data records 122 associated with the user, other users or accounts associated with the branch location, or other users or accounts associated with an entity including both locations. The generated information can include information which may be predictive as to a basis for an interaction, as is further described with regard to the interaction basis predictor 110. The generated information can include information which may be of varying levels of relevance, as is further described with regard to the user interface 114. For example, recent data records 122 associated with a same user may be more predictor or relevant than stale data records 122 from other users in other business units of the entity.

The entity information generator 101 can include at least one interaction basis predictor 110 configured to predict an interaction basis or other information associated with an entity. For example, the interaction basis information can include historical records may be associated with a predicted interaction basis. Such systems can include, for example, machine learning models such as random forests or support vector machines, where the models are trained based on historical records including account information (e.g., claims, premium changes, renewal, binding, or any other information accessible to the interaction basis predictor 110). For example, where twenty historical data records 122 exist, the oldest nineteen can be employed as predictors, and the most recent can be employed as a target or label. Such a model can be employed across any number of clients or accounts.

In some embodiments, the entity information generator 101 can omit one or more components, such as the interaction basis predictor 110. For example, some embodiments may present information contained in historical data records 122 without generation of new information. That is, the interaction basis information can be an assemblage or pre-existing information. Such a technique can, for example, reduce storage space or operation, relative to other embodiments.

The interaction basis prioritizer 112 can determine a relevance for one or more display items. For example, the relevance can correspond to a recency associated with the display item (e.g., recent items can have greater relevance than older items). The interaction basis prioritizer 112 can compare a timestamp of a display item to a predefined threshold or to another timestamp (e.g., of a display item, data record 122, or so forth) to determine a relevance. The relevance can correspond to an entity or sub-entity relationship. For example, a data record 122 associated with a same individual can correspond to greater relevance than another individual within a same department, which can, in turn, correspond to greater relevance than another department. The relevance can correspond to a communications channel. For example, a previous call related to a policy question may have greater relevance than an email or other communique. The relevance can correspond to a change type. For example, a change to a premium amount or coverage exclusion can be associated with a higher relevance than a reassignment of a re-insurer. The relevance can correspond to a content of a data record 122. For example, a change to a policy premium which is less than a threshold (e.g., less than 5%) can be associated with a relatively low relevance, wherein a change to a policy premium which is greater than a threshold (e.g., greater than 20%) can be associated with a relatively high relevance. In some instances, a relevance can correspond to a combination of inputs. For example, a duration of a previous call, when taken in combination with a negative survey score associated with the call, can be associated with a relevancy of the topic of the previous call.

The interaction basis prioritizer 112 can determine one or more relevancy scores for each data item. For example, selected or prioritized data items can be ordered according to the relevancy scores. The interaction basis prioritizer 112 can flag an entity interaction or route a communication (e.g., to a relevant department) based on the relevancy score. For example, upon receiving a phone call having a high relevance related to a billing department, the interaction basis prioritizer 112 can cause the user interface 114 to present the call to a client support agent associated with billing support, or another related resource. The display items can depend on a context. For example, where a client support agent is accessing a view associated with a telephonic communication, display items associated with prior calls may be depicted; where a client support agent is accessing a view associated with a billing issue, the display items may be associated with payment history.

The display items can be generated, prioritized, etc. according to various weights or thresholds associated with any features thereof. Thus, adjustments to the weights or thresholds can be implemented without changing an underlying code base.

The entity information generator 101 can include at least one user interface 114 to present interaction basis information. For example, the user interface 114 can present a subset of the available interaction basis information, or an order of display according to the selection of the interaction basis prioritizer 112. The presented information can include all or a portion of information in a data record 122. For example, the user interface 114 can include one or more display items corresponding to one data record 122, or one or more display items corresponding to more than one display item (e.g., a number of contacts in a last 30 days, an average survey response, a number of accounts, etc.).

The user interface 114 can generate one or more display items independent of another display item. For example, the user interface 114 can generate a display item based on a number of calls in a trailing 30-day period, or a total account value, which is separate from other display items. Thus, various display items can be added or removed in a modular fashion. One or more such display items can be disabled based on, or without regard to, an associated relevance received from the interaction basis prioritizer 112. Each display item can correspond to any number of data records 122.

As indicated above, in some embodiments, the entity information generator 101 may not generate actual predictions of an interaction basis. However, presentation of historical information (e.g., facts) to a client support agent can aid the agent in accessing certain resources, or can, in some embodiments, cause the user interface 114 to display information which may be useful. For example, based on a high relevancy of a billing issue, the user interface 114 can generate a display item corresponding to a change to a recent bill, or provide a link to access such a resource.

Referring now to FIG. 2, a data flow diagram 200 indicating a data flow associated with the entity information generator 101 of FIG. 1 is presented, according to some embodiments. Some data items 202A associated with a first data store or interface, and some data other items 202B associated with a second data store or interface (collectively, data items 202) are received by the signal ingestor 102. As indicated, multiple data items 202 can be sourced from any number of data sources, such as the transmission server 130 or reception server 140 depicted in FIG. 1. The signal ingestor 102 can provide the data items 202 to a data record generator 104.

The data record generator 104 can populate a data store 204 (e.g., comprising the data repository 120) with various data records 122. For example, the data record generator 104 can accumulate data records 122 over time, as further signals are ingested by the signal ingestor 102. The data records 122, either upon their initial generation or thereafter, can be enriched with predefined or other information, such that derivatives of the data store 204 (e.g., portions thereof) may be referred to as an enhanced data store 206. Such a nomenclature is not intended to be limiting, and references to a data store 204 can refer generally to a data store 204 including enriched data record 122, or lacking such information. Moreover, the enhanced data store 206A may be generated according to a sequence of enrichment operations. For example, a first enrichment operation, such as the fast branch of the data enrichment process, can generate a first instance of the enhanced data store 206A from the data store 204. A second enrichment operation, such as the slow branch of the data enrichment process, can generate a second instance of the enhanced data store 206B from the first instance. In some embodiments, the second data enrichment operation may be performed responsive to a completion of the first data enrichment operation.

The interaction basis contextualizer 108 can generate interaction basis information 208 based on data items 202, such as data items stored in the data store 204. For example, the interaction basis contextualizer 108 can retrieve data items 202 according to their association with an entity. In some embodiments, a number or content of data records 122 associated with an entity can exceed a number of items which are displayed via a user interface 114. Moreover, a prioritization of the various data items 202 can cause varying items to be displayed with varying prominence.

The interaction basis prioritizer 112 can prioritize the interaction basis information 208 based on a display output for display via the user interface 114. For example, a display output configured to display a most relevant 3, 5, or 10 items can receive, from the interaction basis prioritizer 112, a subset of the interaction basis information 208 according to a highest relevance score as prioritized interaction basis information 210. In another example, the user interface 114 can include a scrollable list ordered according to a prioritization corresponding to the relevance score. The relevance score is not intended to be limiting, and the display can further depict other information such as predetermined information, or information displayed according to a manual entry (e.g., the user interface 114 can receive an indication of a note which is manually associated with an entity such that useful information can be available for a subsequent entity interaction). In some embodiments, the prioritized interaction basis information 210 is generated during or torques upon a recipe of an interaction (e.g., email, call, website visit). In some embodiments, the prioritized interaction basis information 210 is retained subsequent to its generation. (e.g., as entity information 126).

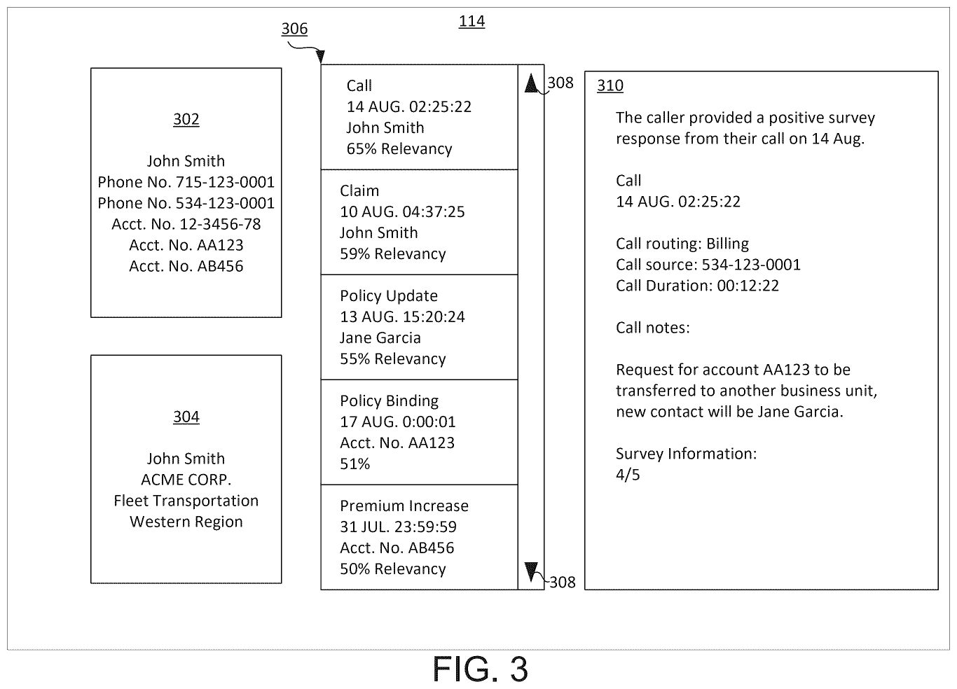

FIG. 3 depicts a user interface 114 to present interaction basis information, according to some embodiments. Particularly, the user interface 114 can present first entity information 126 associated with a caller (e.g., based on a phone number or other information received by the entity information generator 101). For example, the signal ingestor 102 can receive a query associated with an incoming call, and a phone number. The data record generator 104 can generate data records 122 for display, the data records 122 including the first entity information 302, such as a username, one or more account numbers, a received phone number or any other phone numbers associated with the account. The data records 122 can include the second entity information 304 including other entity information 126 such as a company department, or so forth.

The data record generator 104 can generate data records 122 including first interaction basis information 306 including various historical data records 122 (or data fields thereof) prioritized for display according to a relevancy. As depicted, the user interface 114 can display a subset of an available number of data records 122, along with a control 308 to display further data records 122. The user interface 114 can present the various data records 122 as selectable. Upon a selection of a data record 122 (or an automatic presentation of a most relevant data record 122), the user interface 114 can display further information associated with the data record 122. For example, the second interaction basis information 310 can include further details associated with the selected record. For example, one or more names, addresses, or effective dates for an account may be provided according to a priority of such information.

In some embodiments, the second interaction basis information 310 includes a composite of one or more data records 122. For example, the second interaction basis information 310 can provide a statement: “The caller provided a positive survey response from their call on 14 August.” Such information can be derived from various data items such as a call log, call date-time group, survey response, and so forth. Further, the second interaction basis information 310 can include additional or constituent information, such as information organized according to a prioritization.

Various depicted elements can vary over time, corresponding to ongoing data enrichment operations. For example, a first set of elements can be presented responsive to a data record 122 including information which is not enriched, or which is enriched according to one branch of the data enricher 106. A second set of elements can be provided subsequent to the first set, upon a completion of another branch of the data enricher 106. For example, the interaction basis information 306 can be updated, modified, supplemented, re-ordered, pruned, etc.

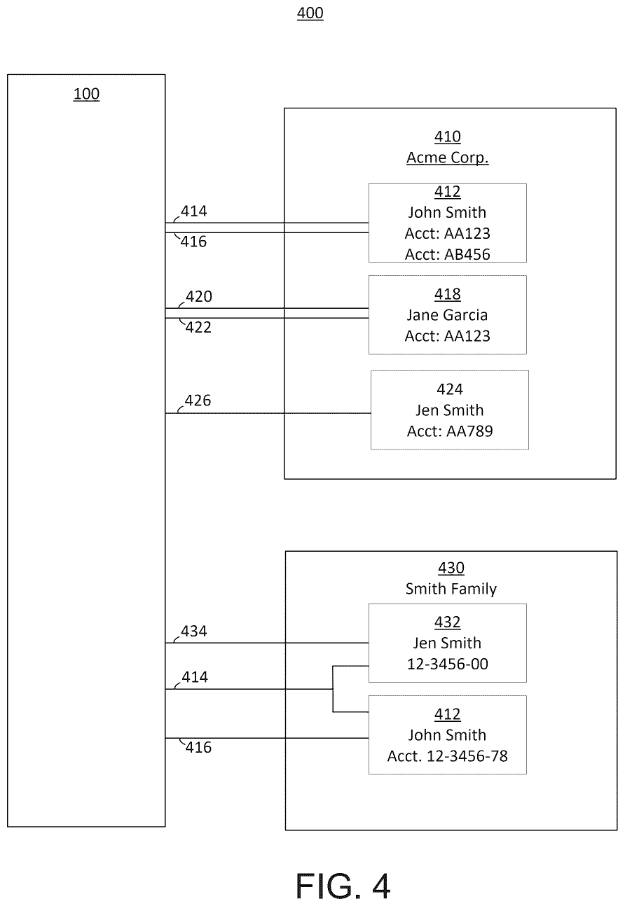

Referring now to FIG. 4, an entity relationship diagram 400 depicts a variety of entities associated with an organization and communication channels associated therewith, according to some embodiments. A first entity 410 (depicted as Acme corp.) is associated with three constituent entities. The three entities, which may be referred to as sub-entities with regards to the first entity, are depicted as individuals, but may, in various embodiments, correspond to accounts, departments, or so forth.

A first sub-entity 412 is depicted as associated with a first communication channel 414 and a second communication channel 416. The communication channels can refer to any indication of a source of information such as an email address, IP address or range, an identity token associated with a mobile device, or a telephone number. Thus, the first communication channel 414 and second communication channel 416 can refer to an email address and a telephone number, two telephone numbers (e.g., a home number and cell number or a cell number and a work number). The phone number, email, or other indication of a communications channel may further be indicative of an entity identity. For example, a phone number or email can be a unique identifier for an individual, or another entity (e.g., in the case of a shared email address). Thus, the system 100 can determine an entity identity based on the, for example, phone number corresponding to an incoming call. The system 100 can further associate one or more accounts associated with the incoming call according to an association between the account and an indication of the communications channel (e.g., the phone number). The association can include a direct association between the communications channel and the accounts. The association can include a first association between the communications channel and an entity identity, and a second association between the identified entity and the accounts.

A second sub-entity 418 is depicted corresponding to a third 420 and fourth communications channel 422. The second sub-entity 418 can be associated with any number of accounts, including, for example, one or more unique accounts, or accounts shared with one or more other entities (e.g., with the first entity). A third sub-entity 424 corresponds to a fifth communication channel 426. A second entity 430 includes a different set of subentries relative to the first set, any of which may be common therewith (e.g., John Smith is a member of both sets). The various substitutes are associated with various communication channels, and specifically, the first sub-entity 412 is associated with the first 414 and second communication channel 416, wherein the fourth sub-entity 432 is also associated with the first communications channel and, further associated with a sixth communication channel 434.

Any of the depicted relationships may or may not be reflected in the data store 204 of FIG. 2. For example, information which is stored in a data store, but has not generated a signal corresponding to a connector of the signal ingestor 102 may not be ingested. Further, some information may be present in the data store 204 of FIG. 2 which is not reflective of a relationship. For example, a signal including information with a new authorized user may, according to a rule associated with a particular data store, supersede a previously indicated authorized user. However, a connector associated with the signal ingestor 102 may not provide an indication to the data record generator 104 to edit or prune previously generated data records 122. Thus, the data store 204 information can vary from source information of various data stores, such that upon a generation of first information, the data enricher 106 can prune or update various data records 122 based on a received signal.

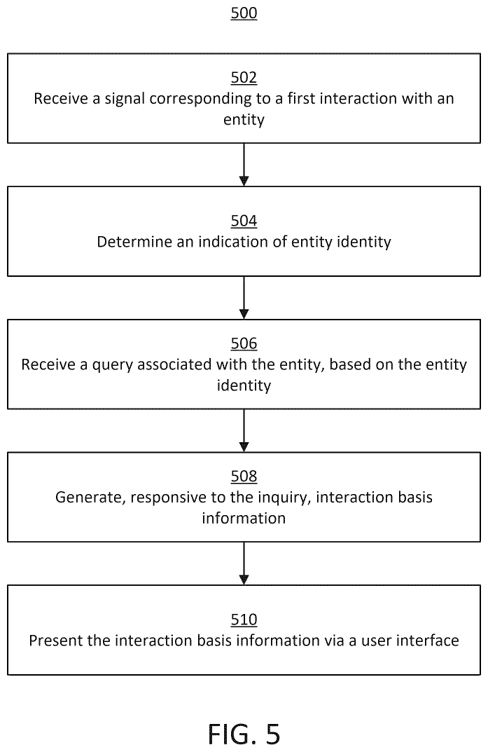

FIG. 5 depicts an example data flow diagram for a method 500 of entity information generation, according to some embodiments. The method 500 can be performed by one or more devices or elements of, for example, the entity information generator 101 of FIG. 1 or otherwise according to the present disclosure. In brief summary, at operation 502, one or more processors receives a signal corresponding to a first interaction with an entity. At operation 504, the one or more processors determines an indication of entity identity based on the signal. At operation 506, the one or more processors receives a query associated with the entity, the receipt based on the entity identity. At operation 508, the one or more processors generates interaction basis information based on the signal. At operation 510, the one or more processors presents the interaction basis information via a user interface 114.

Referring again to operation 502, a signal corresponding to a first interaction with an entity is received. The signal can be associated with, for example, a first instance of a telephonic communication. The signal can include various data fields, such as fields provided incident to an operation of a system 100 including various data stores or interfaces, whereupon the signal is received according to a connector monitoring a link between a first system component and a second system component, wherein neither of the first system component or the second system component addresses (e.g., explicitly address) the signal to the connector.

Referring again to operation 504, an indication of an entity identity is determined based on the signal. For example, the entity information generator 101 can interrogate the data fields of the signal for a signal corresponding to a format, label, tag, etc., associated with a telephone number (e.g., a phone number corresponding to the first instance of the telephonic communication). The telephone number can be or be included in an indication of entity identity. For example, other data records 122 can be associated with the entity based on the provided phone number, or enriched data associated with the phone number (e.g., a customer name or other unique identifier, policy number, account number or so forth). The indication of the entity identity can include various data fields which can be included in the signal or received according to one or more data enrichment processes. For example, either of the signal or enrichment information associated therewith can include an account number. In some instances, both of the signal and the enrichment information can include an account number, such as where the enrichment modifies, extends, concatenates, or reformats the account number, or a label or tag associated therewith (e.g., to recaption “useid_sysdb” or “Header_37” to another account number identifier).

Referring again to operation 506, a query associated with the entity is received. The receipt can be based on the entity identity. For example, the query can be a periodic query or a query responsive to a second instance of a telephonic communication. For example, the second instance of the telephonic communication can be associated with a same or different telephone number as the first telephonic communication. The query can be generated during the telephonic communication. For example, the system can receive the telephonic communication (e.g., during an alerting or active call time period), and the query can be generated responsive to the call, such as to aid in routing the call or to present relevant information to a client support agent. In one example, the client support agent is a human, and the presentation is a graphical depiction of a graphical user interface 114. In another example, the client support agent is an automated system, and the presentation is historical data, based on which, the client support agent can present (e.g., telephonically) options for selection by a caller, such as to confirm or select a basis for the current call.

Referring again to operation 508, interaction basis information is generated based on the signal. The interaction basis information can include or omit, according to various embodiments, historical information which may be relevant to a current interaction (e.g., call), or a prediction of a basis for the current interaction. The generation of the interaction basis information can include a selection of one or more data records 122 or data fields thereof, a combination of various data records 122, an enrichment of various data records 122, etc. Some interaction basis information is generated prior to a receipt of the query, such as according to a periodic batch process. Other interaction basis information is generated responsive to the query. For example, the entity information generator 101 can match the entity identity determined at operation 504 to a field of a machine readable record (e.g., phone number field) to determine that a human readable record (e.g., a call log from a previous call) shares a context with the current call. The entity information generator 101 can parse the human readable record to determine a content of the previous call. The interaction basis information can be based on the content. For example, where a manual billing adjustment is applied following issuing of one or more prior invoices, such information may be relevant to a current call (e.g., a list of the historical adjustment, along with any call notes or associated data may be presented, or a prediction of a billing issue can be provided). In another example, where call notes include an indication of a billing adjustment amount or a particular policy type, other data records 122 associated with billing requests or various policy types may be retrieved, prioritized, flagged, or otherwise based on such content. Numerous other interaction basis information can be provided according to a particular data set and interaction. For example, further interaction basis information can be retrieved in response to receipt of an email, web interface, or other interaction medium. Thus, the generated interaction basis information can be based on the content of the first interaction (e.g., a data record 122 generated based on the signal of operation 502).

The interaction basis information can be based on an account type. For example, the entity information generator 101 can determine one or more account types based on the indication of identity (e.g., the phone number, an account number, or various other indications according to various embodiments of the present disclosure). Various interaction basis information can be associated with various account types. Thus, either of the generation of the interaction basis information or the prioritization thereof (e.g., at operation 510) can be based on such a type.

Referring again to operation 510, the interaction basis information is presented via a user interface 114. The presentation can be a graphical, audible, or according to other methods of presentment (e.g., data streams, signals, and the like). In some embodiments, the presentation can include interaction basis information presented to a display for a client support agent receiving a telephonic communication, such as the telephonic communications referred to with regard to operations 502, 504, and 506. The presentment be provided incident to a selection or prioritization received from the interaction basis prioritizer 112, or other aspects of the present disclosure.

FIG. 6 is a block diagram illustrating an architecture for a computer system that can be employed to implement elements of the systems and methods described and illustrated herein. The computing system 600 includes at least one bus 605 or other communication component for communicating information and at least one processor 610 or processing circuit coupled to the bus 605 for processing information. The computing system 600 can also include one or more processors 610 or processing circuits coupled to the bus for processing information. The computing system 600 also includes at least one main memory 615, such as a random-access memory (RAM) or other dynamic storage device, coupled to the bus 605 for storing information, and instructions to be executed by the processor 610. The main memory 615 can be used for storing information during execution of instructions by the processor 610. The computing system 600 can include at least one read only memory (ROM) 620 or other static storage device coupled to the bus 605 for storing static information and instructions for the processor 610. A storage device 625, such as a solid-state device, magnetic disk or optical disk, can be coupled to the bus 605 to persistently store information and instructions.

The computing system 600 can be coupled via the bus 605 to a display 635, such as a liquid crystal display, or active-matrix display, for displaying information to a user. For example, the display 635 may be configured to present one or more aspects of the user interface 114. An input device 630, such as a keyboard or voice interface can be coupled to the bus 605 for communicating information and commands to the processor 610. The input device 630 can include a touch screen display 635. The input device 630 can also include a cursor control, such as a mouse, a trackball, or cursor direction keys, for communicating direction information and command selections to the processor 610 and for controlling cursor movement on the display 635.

The processes, systems and methods described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. Hard-wired circuitry can be used in place of or in combination with software instructions together with the systems and methods described herein. Systems and methods described herein are not limited to any specific combination of hardware circuitry and software.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component”, “data processing system”, “server”, or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface 114 or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order. Moreover, operations may be added, omitted, substituted, or modified.

Having now described some illustrative implementations, it is apparent that the foregoing is illustrative and not limiting, having been presented by way of example. In particular, although many of the examples presented herein involve specific combinations of method acts or system elements, those acts, and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

References to “approximately,” “substantially” or other terms of degree include variations of +/−10% from the given measurement, unit, or range unless explicitly indicated otherwise. Coupled elements can be electrically, communicative, or operatively coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A method comprising:
receiving, by one or more processors, a signal corresponding to a first interaction with an entity;
determining, by the one or more processors, an indication of an entity identity based on the signal;
receiving, by the one or more processors, a query associated with the entity, based on the entity identity;
generating, by the one or more processors and responsive to the query, interaction basis information, the interaction basis information based on the signal; and
presenting, by the one or more processors, the interaction basis information via a user interface.

2. The method of claim 1, comprising:
storing, by the one or more processors, a first data record corresponding to the signal, the first data record comprising the entity identity and an indication of a first communications channel for the first interaction;
determining, by the one or more processors, a second communications channel associated with the query, the second communications channel different from the first communications channel; and
retrieving, by the one or more processors, the first data record based on the entity identity, wherein the generation of the interaction basis information is based on the first communications channel and the second communications channel.

3. The method of claim 2, wherein:
receiving the signal comprises:
intercepting a message conveyed between a transmission server and a reception server, the transmission server and the reception server separate from the one or more processors; and
storing the signal comprises;
storing the message; and
storing an indication of the transmission server or the reception server.

4. The method of claim 1, wherein the signal is one signal of a plurality of signals, each of the plurality of signals corresponding to a different interaction with the entity, and comprising:
retrieving, by the one or more processors, the plurality of signals associated with the entity;
prioritizing, by the one or more processors, the plurality of signals based on the query; and
presenting, by the one or more processors, the interaction basis information based on the prioritization.

5. The method of claim 4, comprising:
matching, by the one or more processors, the entity identity to a field of a machine-readable record generated based on an entity action, to contextualize a human-readable record;
parsing, by the one or more processors, the human-readable record to determine a content of the first interaction; and
generating, by the one or more processors, the interaction basis information based on the content of the first interaction.

6. The method of claim 4, comprising:
determining, by the one or more processors, an account type based on the indication of the entity identity, wherein:
the indication of the entity identity is an account number for one account type of a plurality of account types; and
the plurality of signals is prioritized based on the account type.

7. The method of claim 1, wherein the interaction basis information comprises historical records of the first interaction and a plurality of further interactions with the entity.

8. The method of claim 7, comprising:
routing, by the one or more processors, a communication channel associated with a second entity interaction to a resource based on the interaction basis information.

9. The method of claim 1, wherein the query includes an indication of an interaction basis.

10. The method of claim 7, wherein the interaction basis information comprises a prediction of an interaction basis, based on the historical records.

11. The method of claim 1, wherein:
the entity comprises a plurality of sub-entities, each sub-entity associated with a unique identifier; and
the interaction basis information is based on a first unique identifier associated with the first interaction, and a second unique identifier associated with the query.

12. The method of claim 1, wherein:
the first interaction with the entity comprises a first electronic communication;
the indication of the entity identity comprises a telephone number associated with the first electronic communication;
the query is generated responsive to a telephonic communication associated with the telephone number, the query generated during the telephonic communication;
the interaction basis information is based on a data record generated based on the signal; and
the interaction basis information is presented to a display for a client support agent receiving the telephonic communication.

13. A non-transitory computer-readable medium having machine instructions stored thereon, the instructions being executable by a processor to cause the processor to perform operations comprising:
receiving, by one or more processors, a signal corresponding to a first interaction with an entity;
determining an entity identity based on the signal;
receiving a query associated with the entity identity;
generating, responsive to the query, interaction basis information based on the signal;
prioritizing the interaction basis information for display; and
presenting prioritized interaction basis information via a user interface.

14. The medium of claim 13, the instructions comprising:
storing, by the one or more processors, a data record corresponding to a message, the data record comprising the entity identity, wherein receiving the signal comprises establishing a connector with a monitoring port, the connector configured to intercept the message.

15. The medium of claim 13, wherein the interaction basis information is based on:
the first interaction; and
a plurality of further interactions with the entity.

16. The medium of claim 15, wherein the prioritization is based on:
a recency of one or more data records of the interaction basis information;
a communications channel for the one or more data records of the interaction basis information; and
a content of the one or more data records of the interaction basis information.

17. The medium of claim 13, the instructions comprising:
routing an electronic communication to a client support agent based on the interaction basis information.

18. The medium of claim 13, wherein the query includes an indication of an interaction basis.

19. The medium of claim 13, wherein:
the entity comprises a plurality of sub-entities, each sub-entity associated with a unique identifier; and
the interaction basis information is based on a first unique identifier associated with the first interaction, and a second unique identifier associated with the query.

20. A server configured to:
receive, from a plurality of connectors corresponding to a plurality of data sources, a first plurality of signals corresponding to one or more first entity interactions;
determine, based on one or more of the first plurality of signals, an indication of an entity identity;
receive a query associated with the entity, a data field of the query corresponding to the entity identity;
generate, responsive to the query, interaction basis information for presentation, the interaction basis information based on the signal; and
present the interaction basis information.
